(19) United States
(12) Patent Application Publication
(10) Pub. No.: US 2010/0253683 A1
(43) Pub. Date: Oct. 7, 2010

(54) NON-UNIFORM TESSELLATION TECHNIQUE

(76) Inventors: Carl J. Munkberg, Malmo (SE); Jon N. Hasselgren, Bunkeflostrand (SE); Tomas G. Akenine-Moller, Lund (SE)

Correspondence Address: TROP, PRUNER & HU, P.C., 1616 S. VOSS RD., SUITE 750, HOUSTON, TX, 77057-2631, US

(21) Appl. No.: 12/618,273

(22) Filed: Nov. 13, 2009

Related U.S. Application Data
(60) Provisional application No. 61/165,751, filed on Apr. 1, 2009.

(51) Int. Cl. G06T 15/30

(52) U.S. Cl. 345/423

(57) ABSTRACT

A non-uniform fractional tessellation technique adapts a tessellation of a base object to the on-screen projection before the domain shader in a graphics processing pipeline executes. The tessellation is adapted in a non-uniform manner such that the distribution of vertices across the surface of the base object is substantially uniform when the base object is projected to screen space. Non-uniform tessellation may be applied to only a portion of the base object, and regular (uniform) tessellation may be applied to the other portion. In such a case, an edge interpolation technique is used to smoothly blend between the non-uniform and uniform portions.

This application claims the benefit of co-pending U.S. Provisional Application Ser. No. 61/165,751, entitled, “NON-UNIFORM TESSELLATION TECHNIQUE,” filed on Apr. 1, 2009, which is incorporated herein by reference in its entirety.

### BACKGROUND

Many visual effects content creation pipelines rely heavily on displaced subdivision surfaces, where a coarse base mesh is hierarchically refined with details added from texture files at finely tessellated levels. Since there is a current trend towards also using these geometric representations in real-time contents, such as gaming applications, some current graphical processing units (GPUs) have added support for tessellation in hardware. The tessellation unit included in the GPUs allows data amplification by tessellating base triangles to many smaller triangles This technique helps in reducing the bus traffic from the host computer to the graphics processor, by sending higher level surface representations instead of finely tessellated geometry.

On current graphics hardware, an input primitive (e.g., line, triangle or quad) is tessellated in parameter space and the vertex positions in the generated mesh are determined by a domain or evaluation shader. This allows approximations of higher order surfaces, such as Bézier patches and subdivision surfaces. In such systems, it is difficult to adapt the tessellation to the final projection on-screen before the domain or evaluation shader, as the shader may move the vertex positions arbitrarily. Generally, the tessellated micro-triangles closer to the camera end up larger than micro-triangles far away when projected on-screen, which can compromise visual quality.

### BRIEF DESCRIPTION OF THE DRAWINGS

FIG. 1 shows examples of edge factors in a regular fractional tessellation technique, in accordance with an embodiment of the invention.

FIG. 2A illustrates an exemplary on-screen projection of an object generated using an exemplary regular fractional tessellation technique in accordance with an embodiment of the invention.

FIG. 2B illustrates an exemplary on-screen projection of an object generated using an exemplary non-uniform fractional tessellation technique in accordance with an embodiment of the invention.

FIG. 3 shows an exemplary regular fractional tessellation technique in accordance with an embodiment of the invention.

FIG. 4 is a block diagram of an exemplary computer system in which the tessellation techniques may be implemented in accordance with an embodiment of the invention.

FIG. 5 shows an exemplary non-uniform fractional tessellation technique in accordance with an embodiment of the invention.

FIG. 6 illustrates a reverse projection remapping technique in accordance with an embodiment of the invention.

FIG. 7 illustrates exemplary perspective-correct vertex distributions that have been remapped for different vertex depths using reverse projection in accordance with an embodiment of the invention.

FIG. 8 illustrates a further example of a remapping technique used for straddling triangles in accordance with an embodiment of the invention.

FIG. 9 is a flow diagram of an exemplary clipping technique used with straddling triangles in accordance with an embodiment of the invention.

FIG. 10 is a flow diagram of another exemplary technique used with straddling triangles in accordance with an embodiment of the invention.

FIG. 11A illustrates an exemplary tessellation pattern generated using the technique of FIG. 10 when only some of the edges of a base triangle straddle a frustum, in accordance an embodiment of the invention.

FIG. 11B illustrates an exemplary tessellation pattern generated using the technique of FIG. 10 when all edges of the base triangle straddle a frustum, in accordance with an embodiment of the invention.

FIG. 11C illustrates an exemplary tessellation pattern generated using the technique of FIG. 10 when all edges of the base triangle do not straddle a frustum, in accordance with an embodiment of the invention.

FIG. 12 illustrates a tessellated base triangle that straddles a view frustum.

FIG. 13 shows an example of a Bézier edge remapping that may be used in one embodiment of non-uniform fractional tessellation in accordance with an embodiment of the invention

FIG. 14 shows an example of a resulting tessellation in which the Bézier edge remapping of FIG. 13 has been employed with edge blending in accordance with an embodiment of the invention.

FIG. 15 shows an example of Bézier curve remapping using edge blending in accordance with an embodiment of the invention.

### DETAILED DESCRIPTION

In accordance with embodiments of the invention, a non-uniform fractional tessellation technique is implemented that adapts the tessellation to the on-screen projection before the evaluation (or domain) shader stage in a graphics processing pipeline, such that the distribution of the sub-objects in the tessellated mesh is substantially uniform when projected on-screen. This even distribution of tessellated objects in screen space results in good visual quality. Moreover, because the adaptation of the tessellation is performed prior to shading, it can be performed with relatively low computational overhead.

Throughout this description, references to an “evaluation shader” and “domain shader” refer to the shader stage in a graphics processing pipeline that, given the barycentric coordinates of the tessellated base object and other attributes (such as control points describing a surface patch), generates on-screen vertex positions. It should be understood that the embodiments of the invention described herein are not limited to a particular graphics processing device and that the examples of particular graphics pipelines are intended to be illustrative only.

“Regular” fractional tessellation, as that term is used in this description, refers to any of a variety of tessellation techniques that do not adapt the tessellation pattern to the on-screen projection. Although a specific example of regular fractional tessellation is described herein, it should be understood that any regular fractional tessellation algorithm may be implemented in various embodiments of the invention.

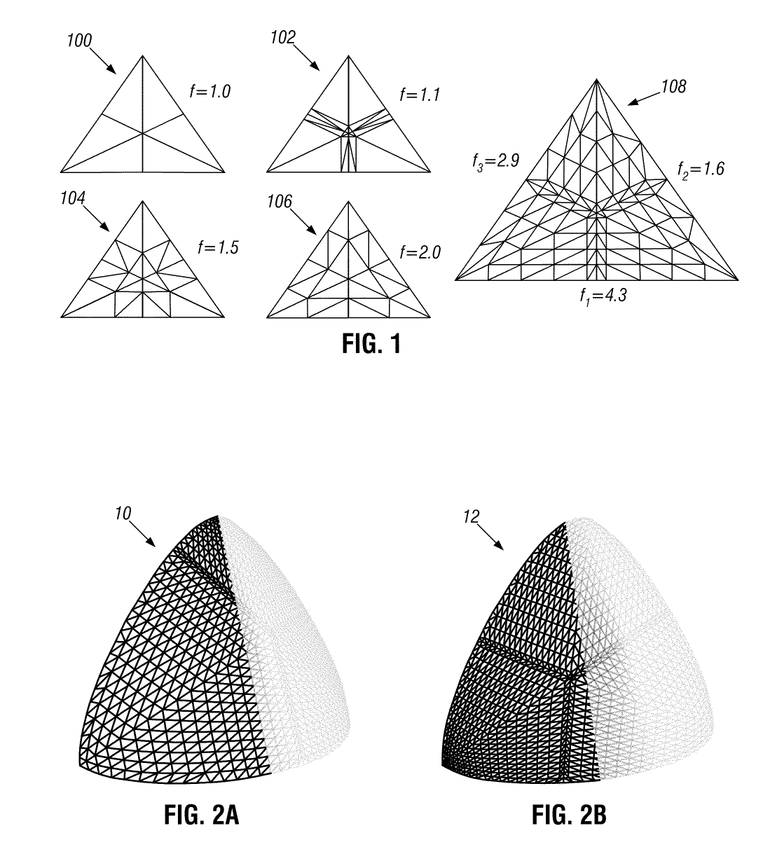

For instance, one example of a regular fractional tessellation technique is a continuous tessellation scheme where floating point weights are assigned to each edge of a base primitive. To allow for a continuous level of detail, new vertices emerge symmetrically from the center of each edge. Furthermore, vertices must move continuously with respect to the tessellation factors. The scheme consists of one inner, regular part, and a transitional part (the outermost edges). Five examples of the continuous introduction of new vertices in a base primitive using regular fractional tessellation are shown in FIG. 1. In examples 100, 102, 104 and 106, all outer edges of the base triangle have a common tessellation factor (f), from f=1.0 to f=2.0. In example 108, each outer edge of the base triangle has a unique tessellation factor, f₁=4.3, f₂=1.6, and f₃=2.9.

Referring to FIG. 1, when performing regular tessellation, each outer edge of the base triangle in examples 100-108 is divided in half for symmetry. Given an edge with tessellation factor f, the integer part off: n=└f┘ is first computed. Then the technique steps n times with a step size 1/f (assuming a half-edge length of one), and finally, connects the current vertex with the midpoint of the edge. This allows for efficient surface evaluation schemes, such as forward differencing, which need uniform step sizes. The other half-edge is tessellated symmetrically, resulting in two smaller distances close to the mid-point.

In the regular tessellation case, the edges of an inner triangle have two vertices fewer than the triangle edges one level further out (see, e.g., example 104 in FIG. 1). Thus, in the case of equal tessellation weights f on all three edges, the first inner triangle will be regular with a tessellation factor of f-1 on all three sides.

In the general setting, however, each outer edge of the base primitive have a unique tessellation factor, such as the example 108 of FIG. 1. With different tessellation factors, the symmetric interior and the outermost edges can be connected by, for instance, a stitching state-machine, such as the machine based on Bresenham's line drawing algorithm.

The edge tessellation factors for base primitives (e.g., triangles) may be computed by, for example, projecting each triangle edge on the image plane and computing their screen-space lengths, giving larger weights to edges closer to the camera. This is reasonable, as one ultimately strives for having equal area of each generated triangle when projected on-screen. For displacement-mapped surfaces, local characteristics of the displacement map, such as heights and normal variations, can also be exploited to determine the tessellation rate.

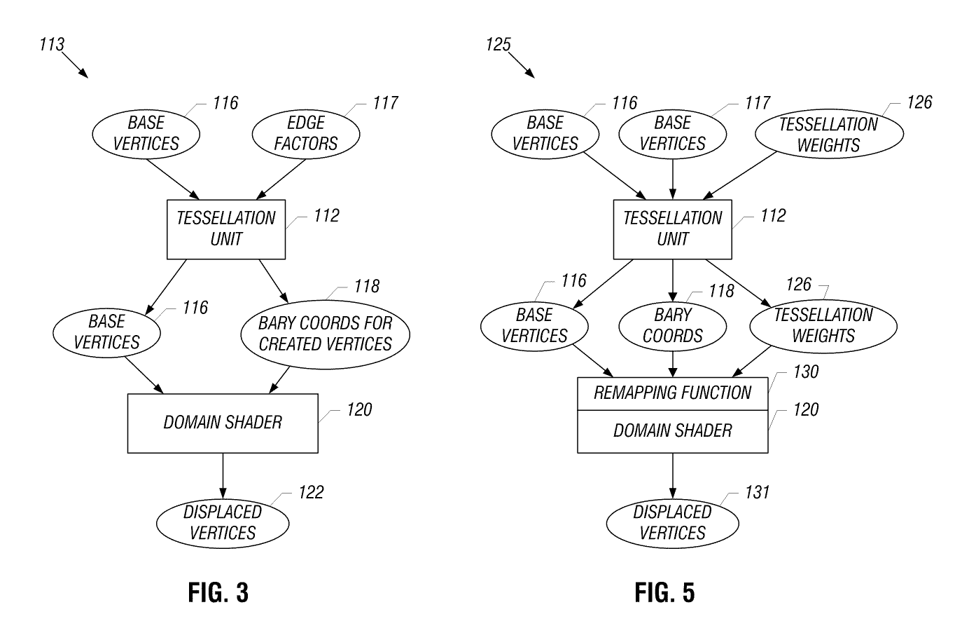

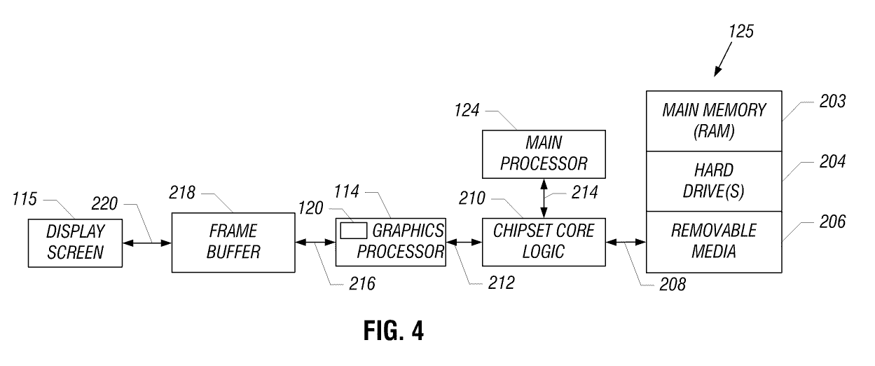

Recent graphics hardware from AMD/ATI supports regular fractional tessellation. In these implementations, and with reference to an exemplary embodiment of a regular tessellation technique 113 shown in FIG. 3, in the GPU pipeline, a tessellation unit 112 (such as in a GPU 114 in FIG. 4) takes the three base vertices 116 and edge tessellation factors 117 of a base triangle as inputs, and generates a set of new vertices. The tessellation unit 112 computes the barycentric coordinates 118, (u,v), for every created vertex across the surface of the base triangle and provides them (along with the base vertices 116) to a domain or evaluation shader 120. The task of this shader 120 is to compute the on-screen position of each vertex as a function of its barycentric coordinates and other attributes, such as control points describing a surface patch. The result of the domain or evaluation shader 120 is the displaced vertices 122

In some embodiments, the edge tessellation factors 117 can be computed either on the system's general purpose processor (such as the CPU or main processor 124 in the system 125 in FIG. 4). Alternatively, the edge factors 117 can be computed by adding an additional pass on the GPU 114 and using “render to vertex buffer” capabilities to execute a shader 120 program that computes the factor 117 for each edge of the base primitive.

A drawback of the regular fractional tessellation algorithm 113 illustrated in FIG. 3 is that created vertices along an edge are distributed uniformly (except locally around the center, where new vertices are introduced). If an edge is parallel to the view direction, a uniform tessellation along this edge is far from optimal. An exemplary embodiment of the invention offers an improvement over regular fractional tessellation that may increase visual quality in screen space and/or reduce the computational overhead since fewer triangles may be generated without adversely affecting visual quality. In such an embodiment, a tessellation pattern is created that preserves the qualities of regular fractional tessellation, such as continuous level of detail and introduction of new vertices at an existing vertex. In addition, the embodiment strives to provide for uniform microtriangle sizes in screen space before the evaluation (or domain) shader 120 is executed. This technique will be referred to herein as non-uniform tessellation.

For instance, in an exemplary embodiment of non-uniform tessellation, given a base triangle, a tessellation is generated using the regular fractional tessellation technique as described above. The barycentric coordinates of each vertex in the generated tessellation that is output from the tessellation unit 112 is then modified (or remapped) based on tessellation weights so that its projection in screen space (e.g., on the display screen 115 in FIG. 1) results in substantially uniform micro-triangle sizes. In one embodiment, this may be achieved by using reverse projection. FIG. 5 represents an exemplary embodiment of a non-uniform tessellation technique 125.

In FIG. 5, as with the regular tessellation technique 113 shown in FIG. 3, the base vertices 116 and edge factors 117 of the base triangle are provided as inputs to the tessellation unit 112. In addition, tessellation weights 126 also are input to the tessellation unit 112. In some embodiments, the tessellation weights 126 may be selected by the user or may be computed by the system, such as in the main processor 124 or the GPU 114 based, for instance, on the depth of the vertex in camera space, a weight assigned to the vertex, or various Bézier parameters. The tessellation unit 112 outputs the base vertices 116 and barycentric coordinates 118 for each vertex generated in the tessellation unit 112 along with the tessellation weights 126. In one embodiment, these coordinates are then remapped by a remapping function 130 in the shader 120 using a reverse projection algorithm. The remapping occurs prior to shading in the shader 120. After remapping the barycentric coordinates, the shader 120 performs its domain shading function to determine the on-screen location of each vertex from the barycentric coordinates (and other attributes). The displaced vertices 131 are output as a result.

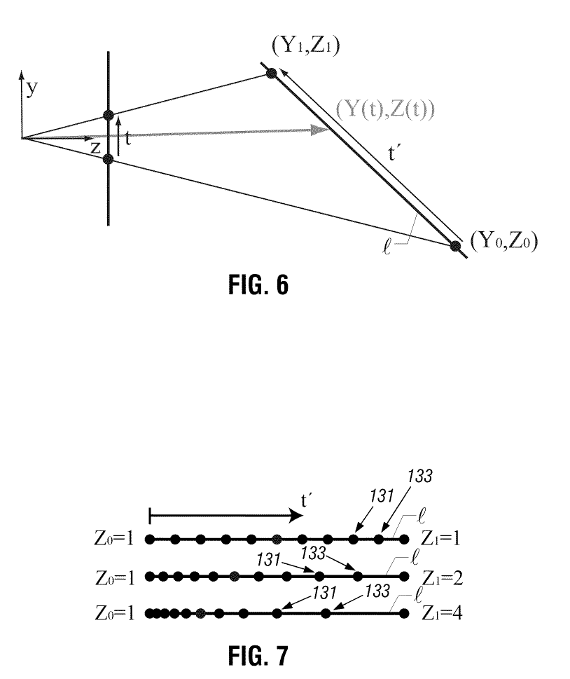

This technique 125 may be understood by way of a non-limiting simple example in two dimensions and with reference to FIG. 6. In FIG. 6, a line l(t′)=(1−t′)(Y₀,Z₀)+t′(Y₁,Z₁) is shown in perspective. Let t′ denote a parameter al the line in camera space and t a parameter along the projection of the line in screen space. Using similar triangles and linear interpolation in t and t′, a relationship is derived between them as:

$${t}^{′} = \frac{t / {Z}_{1}}{t / {Z}_{1} + ( 1 - t ) / {Z}_{0}} \qquad ( 1 )$$

If, in this example, a uniform distribution of points (or vertices) in t is assumed (i.e., a uniform distribution in screen space), then FIG. 7 shows the corresponding distributions of vertices (e.g., vertices 131, 133, etc.) in t′ for various vertex depth values Z₀ and Z₁. FIG. 7 represents a perspective-correct remapping of vertices along an edge (i.e., edge l) for three different combinations of vertex depths. As can be seen in FIG. 7, the larger the vertex depth difference between Z₀ and Z₁, the more non-uniform the resulting vertex distribution is in t′ (i.e., camera space). All the distributions in t′ from FIG. 7 will project back to a uniform distribution of vertices in screen space, by construction.

Next, this reverse projection technique can be generalized to two dimensions. Denote the barycentric coordinates of the triangle in camera space as (u′, v′), and the projected barycentric coordinates in screen space as (u, v). Regular fractional tessellation will create a uniform tessellation pattern in the plane of the triangle, but when projected on-screen, this pattern will no longer be uniform. However, assume we have a regular fractional tessellation in screen space, and reverse-project the pattern out on the triangle in camera space. If the vertex depths in camera space of the base triangle are known, we can generalize the derivation from the two-dimensional example above to form the standard perspective-correct barycentric coordinates for triangles:

$${u}^{′} = \frac{u / {Z}_{1}}{( 1 - u - v ) / {Z}_{0} + u / {Z}_{1} + v / {Z}_{2}^{′}} \\ {v}^{′} = \frac{v / {Z}_{2}}{( 1 - u - Z ) / {Z}_{0} + u / {Z}_{1} + v / {Z}_{2}} \qquad ( 2 )$$

These are the barycentric coordinates in camera space that project to a uniform tessellation in screen space. This can also be seen as a function that adjusts the barycentric coordinates of the triangle (u′, v′) before projection so that they create a uniform distribution of (u, v) in screen space, using three vertex weights, {Zᵢ}.

In the flowchart of FIG. 5, in the GPU-pipeline, the domain or evaluation shader 120 receives as an input the barycentric coordinates 118 before projection, and by simply applying Equation (2) to these barycentric coordinates 118 as a first step in the shader 120 (i.e., in the remapping function 130), the pattern will be roughly uniform in screen-space after projection. Note that the depth values (in camera space) for each vertex (i.e., tessellation weights 126) of the base triangle are applied as an input to the remapping function 130. One approach is to compute these tessellation weights 126 in the shader 120 in a preceding pass, similar to how edge tessellation factors 117 are handled in current hardware solutions. Alternatively, the tessellation weights 126 may be computed in the shader 120, prior to performing the remapping function 130. This latter approach avoids sending data between different passes, but performs redundant work.

To illustrate the resulting on-screen differences between the regular technique 113 and the non-uniform technique 125, exemplary on-screen projections are provided in FIGS. 2A and 2B, which show an on-screen projection 10 of a triangle tessellated using regular tessellation 113 and an on-screen projection 12 of a triangle tessellated using non-uniform tessellation 125. As can be seen in FIGS. 2A and 2B, the non-uniform case 12 results in more uniform screen-space sub-triangles than the uniform case 10.

It should be understood that the tessellation techniques described herein are not limited to triangle primitives, but can work with any type of primitive. For instance, this same reverse projection technique works for quad primitives by using generalized barycentric coordinates. For example, mean value coordinates can work as generalized barycentric coordinates for quads.

The non-uniform tessellation technique 125 described above results in a triangle density that is more uniformly spread out in screen space as compared to regular tessellation. In addition, the non-uniform tessellation technique 125 better preserves close-up detail. However, because the technique is based on perspective-correct interpolation, a problem may occur when part of a base triangle is behind the camera (i.e., a straddling triangle). This problem happens because the mathematics of the perspective-correct interpolation breaks down as the projected triangle “wraps around” infinity. In most settings, this problem is avoided, because triangles are clipped to the near-plane of the view-frustum. However, because the non-uniform fractional tessellation technique 125 may be executed prior to clipping, in some embodiments, the technique may be adapted to handle straddling base triangles.

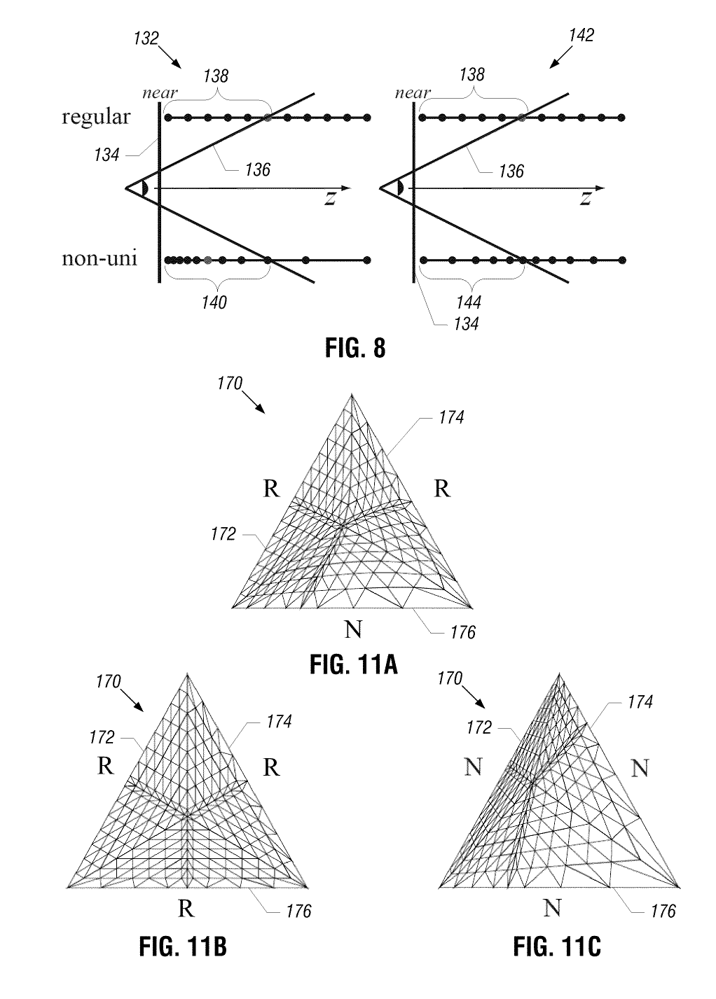

With reference to FIG. 8, a further complication of the non-uniform tessellation technique 125 is that base triangles with one or two vertices in front of the near plane 134, but outside the view frustum 136 will get an unnecessary concentration of vertices outside the frustum 136. This problem is shown in the left part 132 of FIG. 8, where there is a concentration 138 of five vertices outside the frustum 136 when regular tessellation 113 is used, and a concentration 140 of eight vertices outside the frustum 136 when non-uniform tessellation 125 is employed. Thus, in the case of straddling triangles, regular tessellation 113 produces a better end result than the non-uniform technique 125 since more vertices are inside the frustum 136.

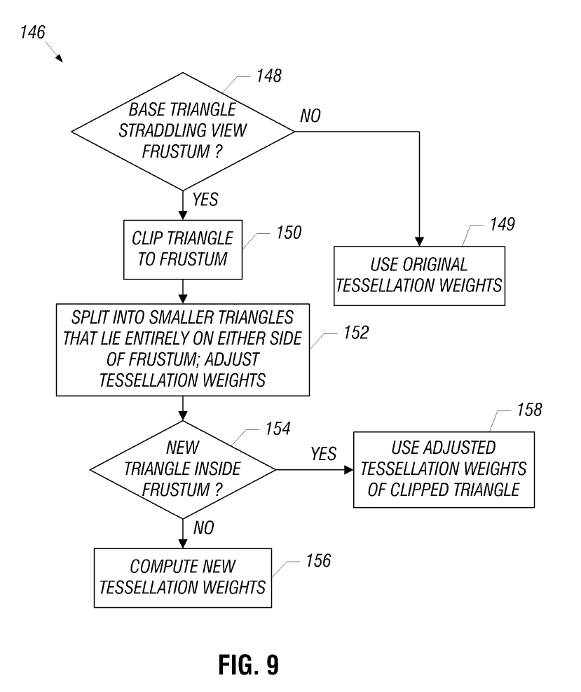

FIG. 9 illustrates a flow diagram of an exemplary clipping technique 146 to handle straddling triangles. In this embodiment, if a base triangle does not straddle a view frustum (diamond 148), no adjustments are needed and the original tessellation weights are used (block 149). If the base triangle does straddle a frustum (diamond 148), it is clipped against the frustum (such as by using Cohen-Sutherland clipping or other appropriate clipping technique) and the tessellation weights are updated accordingly (block 150). The straddling triangles are split into smaller triangles that lie entirely on either side of the clip volume (block 152). For triangles that now lie outside the view frustum (diamond 154), new tessellation weights are computed so that the interpolation distributes triangles closer to the frustum edge (block 156). The updated tessellation weights from the clipped primitive are used for the smaller triangles that are inside the frustum (block 158). The right part 142 of FIG. 8 shows this solution in which it can be seen that the non-uniform tessellation with clipping technique results in the same concentration 144 of vertices outside the frustum 136 as the regular case. This approach 146 may update the tessellation weights for each base primitive in the clipping pass, and no detection is needed in the domain or evaluation shader 120. Although the clipping is costly, it may be performed only on the coarser base geometry in a preceding shader pass, and usually only a fraction of the base triangles need to execute the inner (expensive) loop of clipping.

In an alternative embodiment, instead of the clipping technique 146 shown in FIG. 9, the problems introduced by straddling triangles may be addressed by implementing a technique 160 that combines regular 113 and non-uniform 125 fractional tessellation. In this embodiment, regular tessellation 113 is used for triangle edges that straddle the view frustum and non-uniform tessellation 125 is used on all other edges. To implement this technique 160, an edge interpolation scheme is used to blend between the different tessellation methods over the surface of the triangle.

More specifically, in order to prevent surface cracks between edges tessellated with the regular fractional tessellation scheme 113 and edges tessellated with the non-uniform scheme 125, a technique is needed that allows for definition of a vertex distribution for each edge of the primitive and which smoothly blends the distributions in the interior of the primitive. A starting point for this blending approach may be found in shading techniques which smoothly blend color values over a triangle. As an example, Gouraud shading interpolates three vertex color values Cₚᵢ over a triangle primitive using the barycentric coordinates:

Cᵢₙₜₑᵣₚ=(1−u−v)Cₚ₀+uCₚ₁+vCₚ₂ (3)

As can be seen from Equation (3), the color varies linearly between two color values along each edge of the triangle and is a barycentric combination in the inside of the triangle. This interpolation formula (3) often is used heavily in the graphics pipeline to interpolate vertex attributes.

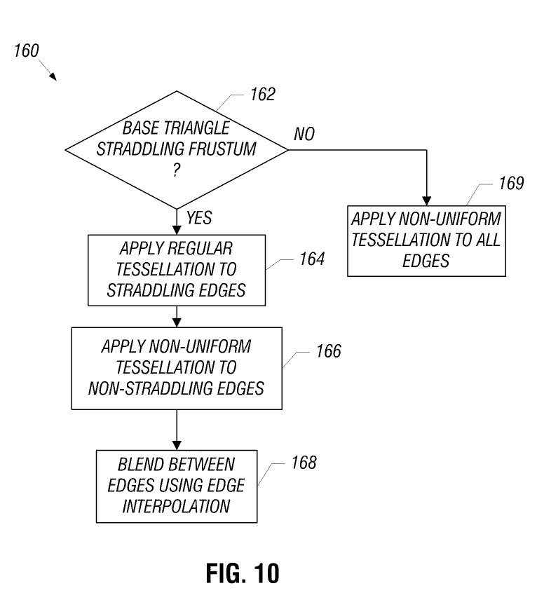

To apply this interpolation scheme to blending between regular and non-uniform tessellation of edges, in one embodiment (as shown in the flow diagram of FIG. 10), if a base triangle is straddling a frustum (diamond 162), each edge of the triangle may be tagged with an identifier that indicates whether regular or non-uniform fractional tessellation will be used on that edge. For instance, edges that straddle a frustum plane may be tagged with an “R,” and regular fractional tessellation will be applied on those edges (block 164). Edges that do not straddle a frustum plane may be tagged with an “N,” and non-uniform fractional tessellation will be used on that edge (block 166). For a consistent result in the displayed on-screen image that has a primitive tagged with different tessellation identifiers, an edge interpolation is performed smoothly inside the primitive (block 168). If the base triangle does not straddle a frustum, then the non-uniform tessellation 125 is applied to all edges (block 169).

To accomplish edge interpolation (i.e., block 168), in one embodiment, three new interpolation coordinates, (α, β, γ), are defined that are based on the edge interpolation barycentric coordinates, (u, v, w). In this scheme, α=1 on the edge where u=0. Thus, α is made proportional to 1-u. Also, β and γ are zero on the edge where u=0. Thus, both β and γ are proportional to u. Taking this constraint into consideration for all three edges, the following formulae result:

α=(1−u)vw

β=u(1−v)w

γ=uv(1−w) (4)

These variables lead to the following edge interpolation formula, which is constant along edges (except at the corners), and can be used to interpolate edge attributes:

$${C}_{interp} = \frac{α {C}_{e 1} + β {C}_{e 2} + γ {C}_{e 3}}{α + β + γ} \qquad ( 5 )$$

FIG. 11A illustrates an application of the edge interpolation technique. As shown in FIG. 11A, each edge 172, 174, 176 of a triangle 170 is tagged as either regular “R” or non-uniform “N” depending on whether that edge straddles a view frustum. Given regular barycentric coordinates (u, v) and non-uniform coordinates (u′, v′), blending between the edges 172, 174, 176 in the interior of the triangle 170 may be accomplished using a formula similar to Equation (5) above. If the first two edges 172, 174 are regular tessellation 113 (i.e., use coordinates (u,v)), and the third edge 176 uses non-uniform tessellation 125 (i.e., uses coordinates u′,v′)), the barycentric coordinates may be modified as follows:

$${u}_{interp} = \frac{α u + β u + γ {u}^{′}}{α + β + γ}$$

$${v}_{interp} = \frac{α v + β v + γ {v}^{′}}{α + β + γ}$$

As a result of Equation (6) above, the tessellation scheme in the interior of the triangle 170 is warped smoothly to enforce the constraints of the edges 172, 174, 176. The resulting blended tessellation pattern is shown in FIG. 11A.

By comparison, FIG. 11B shows the resulting tessellation pattern when all edges 172, 174, 176 of triangle 170 straddle a frustum (i.e., are labeled with identifier “R”) and regular tessellation 113 is applied to each edge. FIG. 11C shows the resulting tessellation pattern when all edges 172, 174, 176 of triangle 170 do not straddle a frustum (i.e., the entire triangle 170 is inside the view frustum). In this case, the edges 172, 174, 176 are labeled with identifier “N” and non-uniform tessellation 125 is applied. In FIG. 11A, the vertices are uniformly distributed such that the sub-triangles generated by the regular tessellation scheme 113 are uniform across the plane of the triangle 170 in camera space. In contrast, in FIG. 11B, non-uniform tessellation places more vertices (non-uniformly) closer to the camera, which results in more uniform screen-space sub-triangle areas.

Returning to FIG. 11A (which shows a blended tessellation between uniform and non-uniform edges 172, 174, 176), in some embodiments, this transition may be introduced smoothly when a primitive intersects a frustum plane to avoid a discrete change in the tessellation pattern (referred to as “popping”). This may be accomplished by introducing an additional blend when edges start intersecting the frustum and smoothly transform from non-uniform fractional tessellation 125 to regular fractional tessellation 113. At the edge which intersects the frustum plane, the barycentric coordinate of the intersection point is computed, and a smoothstep function is used to blend between the regular and non-uniform pattern for that edge, prior to applying the edge interpolation technique described above.

As an example, given a parameter x ∈ [0,1] along the edge, and a transition zone w in which blending is desired, the interpolation kernel is simply a smoothstep function:

$$h ( x ) = \{ \begin{matrix}3 {( \frac{x}{w} )}^{2} - 2 {( \frac{x}{w} )}^{3} & x \leq w \\ 1 & x > w\end{matrix} \qquad ( 7 )$$

In practice, for an edge fully inside or outside the camera frustum, the choice of tessellation scheme per edge is binary: either (u, v) or (u′,v′), as discussed above. However, for an edge that intersects a frustum plane, the choice of tessellation scheme is a smooth blend, as represented by the following equation:

(u_{b}, v_{b})=(1−h(x))(u′, v′)+h(x)(u, v), (8)

and it is (u_{b}, v_{b}) that are fed into Equation (6) for that edge, where h(x) is the smoothstep function defined in Equation (7) above.

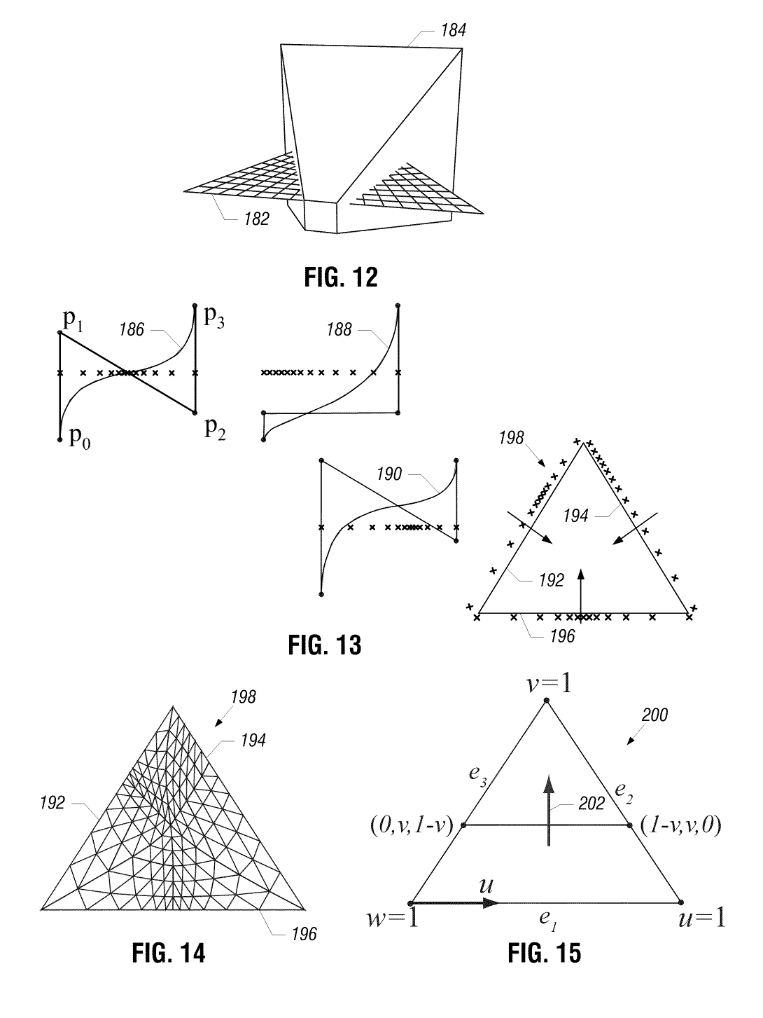

In one embodiment, in a pre-pass, preferably when the tessellation factors for each edge of the base primitive edge are determined, it is also determined if a primitive edge 177 intersects any of the camera view frustum planes, such as plane 178 in FIG. 12. In FIG. 12, the distance to an intersection with plane 178 along the edge 177 is marked with x, and x is used for smooth edge transitions, as previously described. Specifically, based on the parametric coordinate x∈[0,1] along the edge 177, the smoothstep function 179 h(x)∈[0,1] is applied, so that in the transition zone w, x∈[0,w], h(x) specify a smooth blending weight. Thus, as the triangle edge 177 intersects the frustum plane 178, the edge 177 will transform smoothly from non-uniform to regular fractional tessellation.

Up to this point only the case in which one frustum plane intersects the base primitive has been described. However, a base primitive may intersect several frustum planes. To handle all of these cases, the fraction of the edge outside the frustum, (f) for each edge, instead of the distance x to an intersection, is stored. A fraction of the edge outside the frustum f=0 means that the edge is inside the frustum, f∈[0,1] means that the edge intersects the frustum once or twice, and f=1 means the edge is fully outside the frustum. If the primitive moves continuously, so will the fractions. Thus, f is used in place of x as the parameter in Equation (7).

There are some cases in which the perspective remapping technique described above may not be optimal. One such case is when most of the generated triangles in a base triangle 182 end up outside a camera frustum 184, as shown in FIG. 12. In order to produce high quality close to the camera, the triangle 182 is highly tessellated, which can result in many unnecessary triangles that are generated outside the view frustum 184. In such a case, a distribution function that can gather vertices around a point along a base triangle edge could help because such a function could push many of the generated triangles inside the view frustum 184 where they are more useful. In one embodiment, the remapping may be implemented with an algorithm that uses constrained Bézier curves, defined per edge and blended together.

In such an embodiment, a third order Bézier curve is used to remap the vertex distribution along each edge of the base primitive. An example of the Bézier edge remapping is shown in FIG. 13 in which three unique Bézier curves 186, 188, 190 are used to remap the three edges 192, 194, 196 of a base triangle 198 with two degrees of freedom: the y-coordinates of p₁ and p₂. As shown, the curves 186, 188, 190 are used to remap the distribution of vertices along edges 192, 194, 196, respectively, and edge interpolation is used to blend between the distributions in the interior of the triangle 198. For instance, in FIG. 13, the Bézier curve 186 goes through p₀=(0,0) and p₃=(1,1) and remaps all the points in between. Two degrees of freedom are allowed, y₁,y₂∈[0,1] and the two remaining control points are chosen as p₁=(0,y₁) and p₂=(1,y₂).

A third order Bézier curve is given by the following equation:

b(t)=(1−t)³p₀+3(1−t)²tp₁+3(1−t)t²p₂+t³p₃ (9)

The y-component of this curve is of interest, which is denoted b(t) for convenience in this description. Given {pᵢ}, i∈0 . . . 3, b(t) can be written as:

b(t)≡b_{y}(t)=3(1−t)²ty₁+3(1−t)t²y₂+t³ (10)

Note that b(t) must be monotonically increasing for t∈[0,1], to avoid reordering of vertices along the edge. If we constrain y₁y₂∈[0,1], the function will be monotonically increasing. As a result, a uniform distribution t∈[0,1] is warped to t′=b(t)∈[0,1]. This allows for definition of a set of useful distributions, with only two parameters per triangle edge.

This embodiment also may include an edge blending technique, as shown in the resulting tessellation pattern illustrated in FIG. 14. Each Bézier curve is specified per edge and should decline as one moves away from the edge. Referring to FIG. 15, given a triangle 200 with standard barycentric coordinates (u,v), let us look at the edge e₁, with the barycentric coordinate v=0. Assume also that a Bézier curve has been defined along this edge in the manner described above. This curve is denoted bₑ₁(t). As a parameter along edge e₁, we choose u, which goes from zero to one along the edge. The remapped u-coordinate is thus u′=bₑ₁(u). If we move a line 202 perpendicular from the edge e₁ into the triangle in the increasing v-direction, as shown in FIG. 12, the interval in u shrinks to u∈[0,1−v] and we adjust the parameter so that the start and end points of the interval in u still map to 0 and 1, respectively. We also scale the amplitude so that it fades linearly to zero as we approach v=1. This gives us

$${u}^{′} = β ( 1 - v ) {b}_{e 1} ( \frac{u}{1 - v} ) ,$$

which ensures that the curve has maximum influence on the edge e₁ and smoothly declines as we approach v=1. The same procedure is applied to the edges e₂ and e₃, by permutations of the barycentric coordinates. Finally, the three edge remappings are blended together using Equation (5).

Given bₑ₁(u), bₑ₂(v), and bₑ₃(w) defined on the edges e₁, e₂ and e₃, respectively, the remapped barycentric coordinates (u′,v′) are:

$${u}^{′} = \frac{α u + β ( 1 - v ) {b}_{e 1} ( \frac{u}{1 - v} ) + γ ( 1 - w ) ( 1 - {b}_{e 2} ( \frac{v}{1 - w} ) )}{α + β + γ} \\ {v}^{′} = \frac{α ( 1 - u ) ( 1 - {b}_{e 3} ( \frac{w}{1 - u} ) + β v + γ ( 1 - w ) {b}_{e 2} ( \frac{v}{1 - w} ) )}{α + β + γ} \qquad ( 11 )$$

The Bézier edge remapping technique can give more freedom in selecting edge distributions with two parameters per edge. Even more control can be given by allowing p₁ and p₂ to move also in the x-direction, or raise the degree of the Bézier curve, but this means more storage cost per base triangle edge and a higher shader evaluation cost.

It is also possible to replace the Bézier edge curves with other mathematical functions. For instance, a power function may be used as a modified gain function, g(t), with two parameters c and n:

$$g ( t ) = \{ \begin{matrix}{c ( \frac{t}{c} )}^{n} & t \leq c \\ 1 - ( 1 - c ) {( \frac{1 - t}{1 - c} )}^{n} & t > c\end{matrix} \qquad ( 12 )$$

This curve allows a point to be set along the edge of interest (c) and determine the slopes around this point by adjusting the exponent n.

The techniques described herein allow for more flexible tessellation patterns to be generated in real time. The techniques may use fewer triangles with consistent quality (thus providing memory and bandwidth savings) or they may be used to fine tune the tessellation pattern for each primitive. It should be understood that the techniques are not limited to a particular tessellation pattern, but may be used with any pattern that uses generalized barycentric coordinates of the base primitive to specify vertex position. In addition, although the technique has been described with respect to fractional tessellation, it may be employed with any tessellation pattern that specifies vertex position using barycentric coordinates. Yet further, the technique is not limited to a real-time rendering pipeline or perspective-correction, but may also be employed as a more general approach to achieve better control over surface tessellation. In general, the technique takes the uniform tessellation pattern and warps it into a new distribution via the reverse projection algorithm. In other embodiments, other warping techniques, such as the Bézier edge technique described above, may be employed, depending on the particular application in which the non-uniform fractional tessellation technique is employed. Yet further, each edge may have an independent warping function and different or more elaborate LOD measures may be used for the vertex weights.

The techniques and algorithms described herein may be implemented in hardware or in software code, such as in the shader code. Current fractional tessellation hardware already feeds barycentric coordinates to the shader. Thus, in some embodiments, the code for the reverse projection algorithm may be inserted in the beginning of the shader to compute new barycentric coordinates. These coordinates may then be fed to the remainder of the shader, which may differ depending on the particular application in which the shader is employed.

An exemplary embodiment of a computer system in which the techniques described herein may be implemented is shown in FIG. 4. In FIG. 4, a computer system 125 may include a main memory (RAM) 203, a hard drive 204 and a removable medium 206, coupled by a bus 208 to a chipset core logic 210. The core logic 210 may couple to the graphics processor 114 (via bus 212) and the main or host processor 124 (via bus 214) in one embodiment. The graphics processor 114 may also be coupled by a bus 216 to a frame buffer 218. The frame buffer 218 may be coupled by a bus 220 to a display screen 115.

The techniques described herein may be implemented in hardware, as well as in shader code or any combination thereof. In one embodiment, the fractional tessellation may be performed on the CPU 124. In other embodiments, the tessellation can be performed on the GPU 114. The reverse projection algorithm or Bézier edge technique may be implemented in the shader 120 of the GPU 114. In such embodiments, the inputs to the shader 120 may include the positions of all (three) vertices of the base primitive, the barycentric coordinates of the current tessellated vertex, and tessellation weights for all (three) vertices of the base primitive (which typically may be camera space depth values).

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

In the case of a software implementation, the pertinent code to implement any of the techniques described herein may be stored in any suitable semiconductor, magnetic or optical memory, including the main memory 203 and memory associated with shader 120. Thus, in one embodiment, code may be stored in a machine readable medium, such as main memory 203, for execution by a processor, such as the processor 124 or the graphics processor 114.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present invention.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of generating an object for display on a screen, comprising:
receiving a base object for display in screen space; and
tessellating the base object in a non-uniform manner in camera space so that the tessellation is substantially uniformly distributed when projected to screen space.

2. The method as recited in claim 1, wherein tessellating the base object in a non-uniform manner comprises:
generating barycentric coordinates across the surface of the base object; and
remapping the barycentric coordinates so that a distribution of vertices created from the remapped barycentric coordinates is substantially uniform in screen space.

3. The method as recited in claim 2, further comprising defining tessellation weights for base vertices of the base object, wherein the remapping is based on the tessellation weights.

4. The method as recited in claim 3, wherein the tessellation weights are comprised of at least one of base vertex weights, base vertex depths, and Bézier parameters.

5. The method as recited in claim 2, wherein the remapping is performed using reverse projection.

6. The method as recited in claim 2, wherein the remapping is performed by applying a Bézier curve to each edge of the base object.

7. The method as recited in claim 1, further comprising:
tessellating edges of the base object that straddle a view frustum, if any, such that vertices created along those edges are uniformly distributed in camera space;
tessellating edges of the base object that do not straddle a view frustum, if any, such that vertices created along those edges are non-uniformly distributed in camera space; and
blending the tessellation between uniform and non-uniform edges.

8. The method as recited in claim 7, wherein the blending comprises using edge interpolation between uniform and non-uniform edges.

9. The method as recited in claim 1, wherein the tessellation is performed in a graphics processing unit.

10. A graphics processing system, comprising:
a tessellation unit to receive a representation of a base object for display in screen space, the representation including base vertices and tessellation weights for the base object, the tessellation unit adapted to tessellate the base object, including generating barycentric coordinates across the surface of the base object; and
a remapping unit coupled to the tessellation unit to receive the base vertices, the tessellation weights and the barycentric coordinates, the remapping unit adapted to modify the barycentric coordinates based on the tessellation weights such that vertices created from the modified barycentric coordinates are substantially uniformly distributed across the tessellated base object when projected to screen space.

11. The system as recited in claim 10, wherein the remapping unit is included in a graphics processing device.

12. The system as recited in claim 10, wherein the tessellation weights are comprised of at least one of base vertex weights, base vertex depths, and Bézier parameters.

13. The system as recited in claim 10, wherein the remapping unit executes a reverse projection algorithm to modify the barycentric coordinates.

14. The system as recited in claim 10, wherein the remapping unit modifies the barycentric coordinates by applying a Bézier curve to an edge of the base object.

15. The system as recited in claim 10, wherein the tessellation unit is configured to tessellate the base object such that vertices corresponding to the barycentric coordinates along edges of the base object are substantially uniformly distributed along the edges, and wherein the remapping unit is configured to selectively remap barycentric coordinates based on whether an edge straddles a view frustum.

16. The system as recited in claim 15, wherein the remapping unit is configured to selectively remap barycentric coordinates such that vertices along edges of the base object that straddle a view frustum are substantially uniformly distributed along the straddling edges in camera space and vertices along edges that do not straddle a view frustum are non-uniformly distributed along the non-straddling edges in camera space.

17. A medium storing instructions which, when executed by a processing device, cause the processing device to:
tessellate a base object to create barycentric coordinates across a surface of the base object; and
remap the barycentric coordinates based on tessellation weights corresponding to the base object so that a projection of the tessellated base object in screen space has substantially uniformly distributed vertices across its surface.

18. The medium as recited in claim 17, wherein the tessellation weights are at least one of base vertex depths, base vertex weights, and Bézier parameters.

19. The medium as recited in claim 17, further storing instructions to remap the barycentric coordinates along an edge only if that edge does not straddle a view frustum; and blend between edges that are remapped and edges that are not remapped.

20. The medium as recited in claim 17, further storing instructions to:
identify whether the base object straddles a view frustum; and
split a straddling base object into a plurality of sub-objects, where a first portion of the sub-objects is located entirely inside the view frustum and a second portion f the sub-objects is located entirely outside the view frustum; and
remap the barycentric coordinates based on whether the sub-objects are inside or outside the view frustum.
